(19) United States
(12) Patent Application Publication
(10) Pub. No.: US 2014/0372288 A1
(43) Pub. Date: Dec. 18, 2014

(54) METHODS AND SYSTEMS FOR ELECTRONIC MONETARY PAYMENTS

(71) Applicant: Lois C. Hamblet, Vero Beach, FL (US)

(72) Inventor: Lois C. Hamblet, Vero Beach, FL (US)

(73) Assignee: Ziptip, Inc., Wilmington, DE (US)

(21) Appl. No.: 14/004,462

(22) PCT Filed: Mar. 12, 2012
(86) PCT No.: PCT/US12/28720

§ 371 Date: Apr. 23, 2014

Related U.S. Application Data
(60) Provisional application No. 61/452,088, filed on Mar. 12, 2011.

(51) Int. Cl. G06Q 20/32; G06Q 20/10

(52) U.S. Cl. CPC G06Q 20/322; G06Q 20/10
USPC 705/39

(57) ABSTRACT

Computer-implemented methods and systems enable payers to make monetary payments such as gratuities to payees using third-party payment processing services. Payees are assigned electronically-readable unique identifiers, which they can display to potential payers. Payers scan the unique identifiers using mobile devices such as smart phones and send instructions for making payments through a downloaded application.

### CROSS REFERENCE TO RELATED APPLICATION

This application claims priority from U.S. Provisional Patent Application No. 61/452,088, filed on Mar. 12, 2011, entitled METHOD BY WHICH A TIP, GRATUITY OR OTHER MONETARY PAYMENT CAN BE PROCESSED UTILIZING DEVICES AND CODED SYMBOLOGIES WITHOUT USE OF CURRENCY OR CREDIT CARDS, which is hereby incorporated by reference.

### BACKGROUND

The present application relates generally to electronic monetary payment systems.

A gratuity (also called a tip) is a sum of money typically given to certain service sector workers for a service performed. Gratuities are typically paid in cash or added to the amount charged in a credit/debit card transaction. There are numerous problems with current methods of paying gratuities. For example, persons wishing to pay a cash tip often cannot do so if they do not have sufficient cash on hand. They may also not leave a cash tip if they think the tip may be stolen or won't be received by the intended recipient. In addition, some people resist tipping because they find the experience awkward. Moreover, tips in credit/debit card transactions are sometimes not passed on to the intended recipients. Tips in those transactions can also take long periods of time before they are received by the intended recipients. Furthermore, cash tips cannot be easily tracked for use in expense reports by tippers.

### BRIEF SUMMARY OF THE DISCLOSURE

A computer-implemented method in accordance with one or more embodiments transfers payments from payers to payees. Each of the payers and payees maintains a separate account at the same or different third-party payment processing services. The method is implemented in a computer server system communicating with client devices operated by the payers, the payees, and each of the same or different third-party payment processing services over a communications network. The method comprises the steps of: (a) assigning and issuing an electronically-readable unique identifier to a payee, which the payee can display to potential payers; (b) associating the unique identifier assigned to the payee with the account of the payee in a third-party payment processing service; (c) receiving instructions from a mobile device operated by a payer for making a payment to the payee, said instructions identifying the payee based on the unique identifier electronically read by the mobile device, an amount of the payment, and information on an account of the payer at a third-party payment processing service; and (d) transmitting instructions to the third-party payment processing service maintaining the account of the payer to transfer the payment from the account of the payer to the account of the payee.

An electronic payment system is provided in accordance with one or more further embodiments for transferring payments from payers to payees. Each of the payers and payees maintains a separate account at the same or different third-party payment processing services. The system is configured to communicate with client devices operated by the payers, the payees, and each of the same or different third-party payment processing services over a communications network. The system comprises a data storage system for storing data on payers and payees and a computer server system including one or more processors configured to: (a) assign and issue an electronically-readable unique identifier to a payee, which the payee can display to potential payers; (b) associate the unique identifier assigned to the payee with the account of the payee in a third-party payment processing service, and to store data on the unique identifier and the account of the payee in the data storage system; (c) receive instructions from a mobile device operated by a payer for making a payment to the payee, said instructions identifying the payee based on the unique identifier electronically read by the mobile device, an amount of the payment, and information on an account of the payer at a third-party payment processing service; and (d) transmit instructions to the third-party payment processing service maintaining the account of the payer to transfer the payment from the account of the payer to the account of the payee.

A computer-implemented method is also provided of transferring gratuity payments from payers to payee. Each of the payers and payees maintains a separate account at a third-party payment processing service. The method is implemented in a computer server system communicating with client devices operated by the payers, the payees, and the third-party payment processing service over a communications network. The method comprises the steps of: (a) issuing a medallion including a quick response code to a payee, which the payee can display to potential payers; (b) associating the quick response code with the account of the payee in a third-party payment processing service; (c) enabling a payer to download an application on a mobile device to facilitate gratuity payments; (d) receiving instructions through the application on the mobile device operated by a payer for making a payment to the payee, said instructions identifying the payee based on the quick response code electronically read by the mobile device, an amount of the payment, and information on an account of the payer at a third-party payment processing service; and (d) transmitting instructions to the third-party payment processing service maintaining the account of the payer to transfer the payment from the account of the payer to the account of the payee.

### BRIEF DESCRIPTION OF THE DRAWINGS

FIG. 1 is a simplified block diagram illustrating a network in which electronic payment system in accordance with one or more embodiments can be implemented.

FIG. 2 is a simplified flowchart illustrating operation of the payment system in accordance with one or more embodiments.

FIG. 3 illustrates an exemplary medallion in accordance with one or more embodiments.

FIG. 4 illustrates the process of scanning a medallion using a mobile device in accordance with one or more embodiments.

FIG. 5 is an exemplary mobile device screenshot illustrating entry of tip information by a tipper in accordance with one or more embodiments.

FIG. 6 is an exemplary mobile device screenshot illustrating payment records viewable by a tipper in accordance with one or more embodiments.

### DETAILED DESCRIPTION

Various embodiments disclosed herein are directed to an electronic payment system that can be used to quickly and conveniently make monetary payments such as tips or gratuities. As will be described in further detail below, the system assigns payees (i.e., those receiving payments) electronically-readable unique identifiers such as quick response (QR) codes. Payees provide their unique identifiers to payers (i.e., those making payments), who can quickly and easily scan or otherwise electronically read the unique identifier with a mobile device such as a smart phone. Payers can enter the amount of the payment on their mobile devices, and the payment is automatically sent electronically to the payee by the system using a third-party payment processing service such as, e.g., PayPal or American Express Serve. Payers can thereby make payments without using cash or credit/debit cards. Furthermore, payers having access to a payee's unique identifier can make a payment at any time, not just when in the presence of the payee. The system allows payments to be made in an anonymous, confidential, and secure manner.

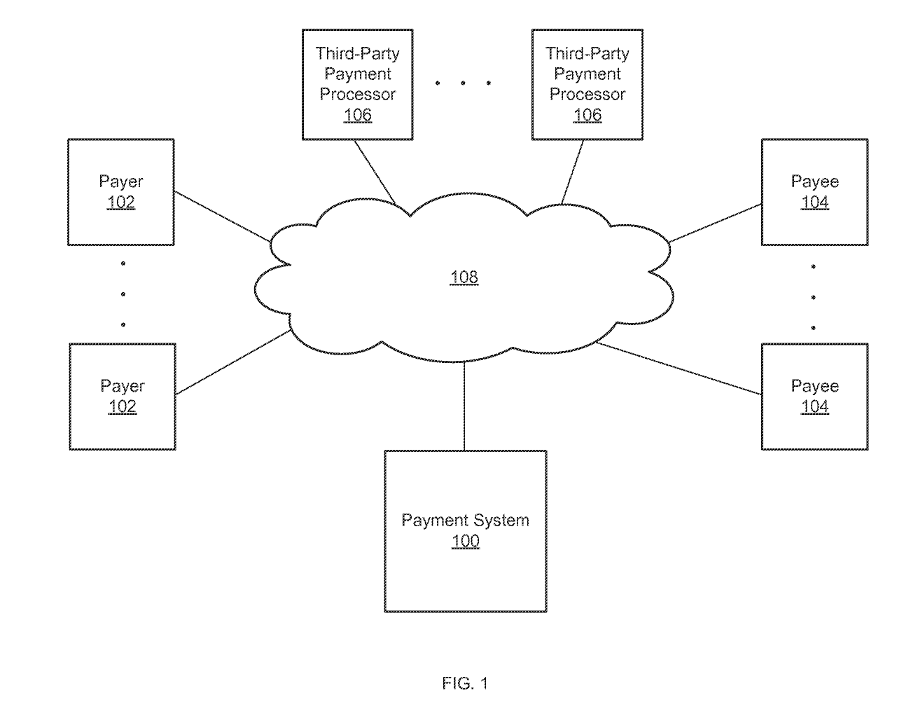

FIG. 1 illustrates an exemplary network, in which an electronic monetary payment system 100 in accordance with one or more embodiments may be implemented. The payment system 100 is preferably implemented in a computer server system, which communicates with a plurality of client devices operated by the users of the system 100, including payers 102 and payees 104. The payment system 100 also communicates with one or more third-party payment processing services 106 such as, e.g., PayPal or American Express Serve. The payment system 100 communicates with the payers 102, payees 104, and third-party processing services 106 electronically over a communications network 108. The communications network 108 may comprise generally any network or combination of networks including, without limitation, the Internet, a local area network, a wide area network, a wireless network, and a cellular network.

The computer server system, in which the payment system 100 is implemented, includes a database configured to store, among other data, account information for each of the users including unique identifiers for the payees 104. The client devices operated by users to access the payment system 100 can comprise generally any computing device that can communicate with the computer server system including, without limitation, personal computers (including desktop, notebook, and tablet computers), smart phones, cell phones, and personal digital assistants.

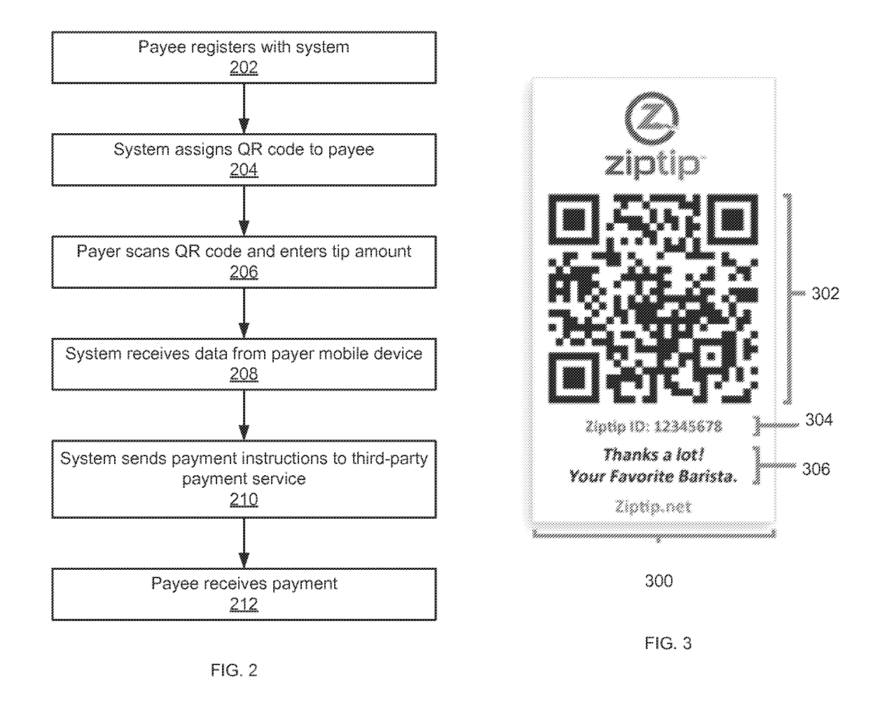

FIG. 2 is a flowchart 200 illustrating exemplary operation of the electronic payment system 100 in accordance with one or more embodiments.

At step 202, a payee 104 sets up an account with the payment system 100. Payees 104 can register online by providing their name, contact information, and information identifying a designated account of the payee 104 at a third-party payment processing service 106 (this can be, e.g., the payee's e-mail address to identify a PayPal account). Payees 104 also select a password for secured access to their respective accounts on the system 100.

At step 204, the electronic payment system 100 assigns a unique identifier for the payee 104 that is electronically readable. By way of example, the unique identifier is a quick response (QR) code that can be scanned by a mobile device such as a smart phone. The unique identifier can alternately comprise other electronically readable symbols or codes such as a barcode. The unique identifier is associated with the payee's account information maintained by the system 100.

The system 100 provides each payee 104 with a “medallion,” which is an image containing a unique identifier that can be displayed or printed. Payees 104 can customize their medallions, e.g., to include their names or a personal message such as “Thanks from your favorite waitress.” FIG. 3 illustrates one example of a personalized medallion 300. The medallion 300 includes a QR code 302, a numerical identification 304 corresponding to the QR code (which can be used in the event the payee 104 cannot scan the QR code), and the payee's personal message 306.

Payees 104 can download their customized medallion 300 and provide it to potential payers 102. For example, payees 104 can have their medallions 300 printed on a business-type card to be handed to potential payers 102. Payees 104 can also print their medallions 300 on virtually any medium that can be displayed to payers 102, including, e.g., signs, T-shirts, mugs, bags, cards, stickers, badges, and hats. Medallions 300 can also electronically displayed by payees 104 on their mobile devices or on their personal pages on social networking sites like Facebook.

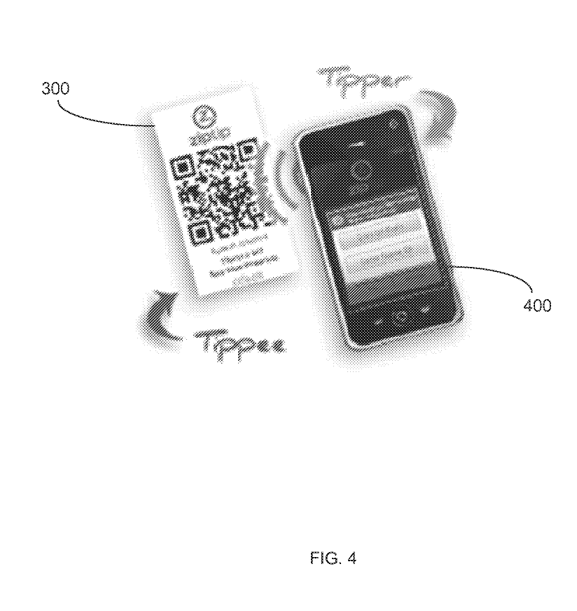

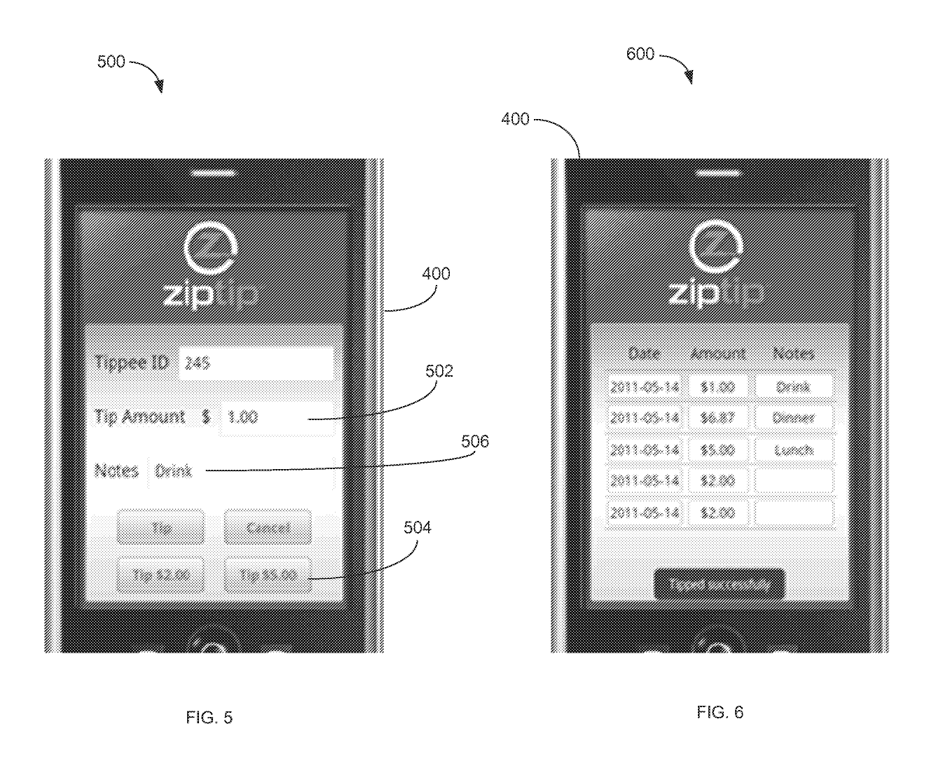

At step 206, a payer 102 wishing to make a payment to a payee 104 utilizes an “app” or application downloaded on his or her mobile device 400 to scan the payee's medallion 300 with the mobile device 400 as shown in FIG. 4. The app allows the payer 102 to enter the amount of the payment as shown in the exemplary screenshot 500 of FIG. 5. The amount can be manually entered in a field 502 or preset amounts can be selected using buttons 504. The payer 102 can also enter notes in a field 506, if desired, to keep track of payments. The payer 102 also enters information such as a password to access his or her account at a third-party payment service 106 (such as, e.g., PayPal) from which payment will be made. The app optionally stores this information on the payer's mobile device 400 or on the payment system 100 for the sake of convenience. The app automatically transmits data related to the payment to the electronic payment system 100.

At step 208, the electronic payment system 100 receives the data relating to the payment from the payer's mobile device 400. The information includes an identification of the payee 104 (based on the scanned QR code), the amount to be paid, and information on the payer's account at a third-party payment processing service.

At step 210, the electronic payment system 100 sends instructions to the third-party payment service 106 maintaining the account of the payer 102 to transfer payment from that account to the account of the payee 104. The account of the payee 104 may be maintained at the same third-party payment service or another third-party payment service 106. The payee 104 can then access the payment through his or her account at step 212.

The system 100 allows payers 102 to maintain anonymity in making payments to payees 104. The system 100 generally emulates cash payments so that no personal information about the payer 102 or payee 104 is revealed as part of the transaction. However, in accordance with one or more alternate embodiments, the app can be configured to allow payers 102 to identify themselves or send messages to payees 104, if desired.

In accordance with one or more further embodiments, the app allows payers 102 to send messages to parties associated with the payee 104. For example, it allows a tipper to send a message to the employer of a tippee, if desired.

The payment processing system 100 provides numerous benefits to both payers 102 and payees 104. For instance, the system 100 ensures that payment is provided directly and only to the intended recipient.

In addition, unlike cash tips or tips paid by credit/debit cards, which typically can only be made in the presence of the recipient, payments using the payment system 100 can be made at generally any time so long as the payer 102 has access to the payee's unique identifier. As discussed above, in one exemplary usage, the payee 104 provides a business card with a QR code printed thereon to the payer 102, who can use it at any time to make a payment.

Additionally, payers 102 can make monetary payments in a secure manner without revealing credit/debit card information or any other information to the payee 104.

Moreover, unlike payments made with debit/credit cards, the payment system 100 does not require a payer 102 to physically provide a credit/debit card or credit/debit card information to the payee 104, the security of which could be compromised.

Furthermore, by using third-party payment processing services 106 like PayPal, the system 100 is able to provide generally instant payment to a payee's account, unlike debit/credit cards, which can require several days or longer for payment settlement. In addition, payment recipients may have to wait an additional time for an employer to allocate payments to employees.

In addition, the system 100 allows the identity of the parties to remain anonymous unlike credit/debit cards, which reveal the payer's name.

The system 100 allows only tipper accounts to make payments. Tippee accounts can only receive payments. Security is thereby enhanced, and allows medallions to be safely distributed and accessible by potential tippers at any time.

The system 100 also allows payers 102 to view records of their payments in order to, e.g., track payments for expense reports. FIG. 6 is an exemplary screenshot 600 illustrating payment records for a payer 102 shown on his or her mobile device 400.

The processes of the electronic payment system 100 described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method of transferring payments from payers to payees, each of the payers and payees maintaining a separate account at the same or different third-party payment processing services, the method implemented in a computer server system communicating with client devices operated by the payers, the payees, and each of the same or different third-party payment processing services over a communications network, the method comprising the steps of:
(a) assigning and issuing an electronically-readable unique identifier to a payee, which the payee can display to potential payers;
(b) associating the unique identifier assigned to the payee with the account of the payee in a third-party payment processing service;
(c) receiving instructions from a mobile device operated by a payer for making a payment to the payee, said instructions identifying the payee based on the unique identifier electronically read by the mobile device, an amount of the payment, and information on an account of the payer at a third-party payment processing service; and
(d) transmitting instructions to the third-party payment processing service maintaining the account of the payer to transfer the payment from the account of the payer to the account of the payee.

2. The computer-implemented method of claim 1, wherein the unique identifier comprises a quick response code.

3. The computer-implemented method of claim 1, further comprising generating a medallion containing the unique identifier, said medallion being printable on a physical medium or electronically displayable.

4. The computer-implemented method of claim 3, wherein the medallion is customizable by the payee to include a personal message.

5. The computer-implemented method of claim 3, wherein the physical medium comprises a sign, a T-shirt, a mug, a bag, a card, a sticker, a badge, or a hat.

6. The computer-implemented method of claim 1, wherein said payment comprises a gratuity.

7. The computer-implemented method of claim 1, further comprising providing a mobile device application downloadable by the payer on the mobile device, said mobile device application facilitating transfer of payment instructions to the computer server system.

8. The computer-implemented method of claim 1, wherein said instructions from the mobile device further include payer notes relating to the payment, and further comprising maintaining a record of payments made by the payer and associated payer notes, and displaying said record on the mobile device.

9. An electronic payment system for transferring payments from payers to payees, each of the payers and payees maintaining a separate account at the same or different third-party payment processing services, the system configured to communicate with client devices operated by the payers, the payees, and each of the same or different third-party payment processing services over a communications network, the system comprising:
a data storage system for storing data on payers and payees;
a computer server system including one or more processors configured to:
(a) assign and issue an electronically-readable unique identifier to a payee, which the payee can display to potential payers;
(b) associate the unique identifier assigned to the payee with the account of the payee in a third-party payment processing service, and to store data on the unique identifier and the account of the payee in the data storage system;
(c) receive instructions from a mobile device operated by a payer for making a payment to the payee, said instructions identifying the payee based on the unique identifier electronically read by the mobile device, an amount of the payment, and information on an account of the payer at a third-party payment processing service; and
(d) transmit instructions to the third-party payment processing service maintaining the account of the payer to transfer the payment from the account of the payer to the account of the payee.

10. The electronic payment system of claim 9, wherein the unique identifier comprises a quick response code.

11. The electronic payment system of claim 9, wherein the computer server system is further configured to generate a medallion containing the unique identifier, said medallion being printable on a physical medium or electronically displayable.

12. The electronic payment system of claim 11, wherein the medallion is customizable by the payee to include a personal message.

13. The electronic payment system of claim 11, wherein the physical medium comprises a sign, a T-shirt, a mug, a bag, a card, a sticker, a badge, or a hat.

14. The electronic payment system of claim 9, wherein said payment comprises a gratuity.

15. The electronic payment system of claim 9, wherein the computer server system is further configured to provide a mobile device application downloadable by the payer on the mobile device, said mobile device application facilitating transfer of payment instructions to the computer server system.

16. The electronic payment system of claim 9, wherein said instructions from the mobile device further include payer notes relating to the payment, and wherein the computer server system is further configured to maintain a record of payments made by the payer and associated payer notes, and to display said record on the mobile device.

17. A computer-implemented method of transferring gratuity payments from payers to payees, each of the payers and payees maintaining a separate account at a third-party payment processing service, the method implemented in a computer server system communicating with client devices operated by the payers, the payees, and the third-party payment processing service over a communications network, the method comprising the steps of:
(a) issuing a medallion including a quick response code to a payee, which the payee can display to potential payers;
(b) associating the quick response code with the account of the payee in a third-party payment processing service;
(c) enabling a payer to download an application on a mobile device to facilitate gratuity payments;
(d) receiving instructions through the application on the mobile device operated by a payer for making a payment to the payee, said instructions identifying the payee based on the quick response code electronically read by the mobile device, an amount of the payment, and information on an account of the payer at a third-party payment processing service; and
(d) transmitting instructions to the third-party payment processing service maintaining the account of the payer to transfer the payment from the account of the payer to the account of the payee.

18. The computer-implemented method of claim 17, wherein the medallion is customizable by the payee to include a personal message.

19. The computer-implemented method of claim 17, wherein the medallion is printable on a physical medium including a sign, a T-shirt, a mug, a bag, a card, a sticker, a badge, or a hat.

20. The computer-implemented method of claim 17, wherein said instructions from the mobile device further include payer notes relating to the payment, and further comprising maintaining a record of payments made by the payer and associated payer notes, and displaying said record through said application on the mobile device.
